(19) United States
(12) Patent Application Publication
(10) Pub. No.: US 2006/0033811 A1
(43) Pub. Date: Feb. 16, 2006

(54) Integrated broadband telecommunications A/V appliance and device

(76) Inventor: J. Hutton Pulitzer, Addison, TX (US)

Correspondence Address: JACKSON WALKER LLP, 2435 NORTH CENTRAL EXPRESSWAY, SUITE 600, RICHARDSON, TX, 75080, US

(21) Appl. No.: 11/194,418

(22) Filed: Aug. 1, 2005

Related U.S. Application Data
(60) Provisional application No. 11/184,030, filed on Jul. 30, 2004.
(60) Provisional application No. 11/184,031, filed on Jul. 30, 2004.
(60) Provisional application No. 11/184,032, filed on Jul. 30, 2004.
(60) Provisional application No. 11/184,033, filed on Jul. 30, 2004.
(60) Provisional application No. 11/184,034, filed on Aug. 3, 2004.
(60) Provisional application No. 11/184,035, filed on Aug. 4, 2004.
(60) Provisional application No. 11/184,036, filed on Aug. 5, 2004.

(51) Int. Cl. H04N 7/14; H04L 12/66

(52) U.S. Cl. 348/14.01; 370/352

(57) ABSTRACT

An information appliance including a network connection, a telecommunications processor connected to the network connection to provide two-way communication and a video processor connected to the network connection. An optical reader is connected to the network connection. A request signal is sent to a server via the network connection in response to the optical reader reading a code. An associated provider sends content to said information appliance in response to the received request signal. A system for providing on-screen management of content delivery to an audio-video telecommunications terminal including a network connection, a telecommunications processor connected to the network connection and a video processor connected to the network connection. A display on the telecommunications terminal is connected to the video processor. The display provides visual displays for programming the delivery of content to the video processor via the network.

### RELATED APPLICATIONS

This application claims priority to U.S. Provisional Patent Application, Ser. No. 60/592,846, entitled “OPTICAL COMMAND TELECOMMUNICATIONS DEVICE” filed on Jul. 30, 2004, having J. Hutton Pulitzer, listed as the inventors, and Ser. No. 60/599,152, entitled “ON-SCREEN INFORMATIONMANAGEMENT SYSTEM FOR A/V TELECOMMUNICATIONS TERMINAL” filed on Aug. 5, 2004, having J. Hutton Pulitzer, listed as the inventors the entire content of each of which is hereby incorporated by reference.

### TECHNICAL FIELD OF THE INVENTION

The invention relates to the field of video telephony, in particular to an integrated multi-network video telephones.

### BACKGROUND OF THE INVENTION

The combination of video and audio channels provide a unique platform for interpersonal communication. With the availability of broadband Internet network connections in the home, there is an opportunity to provide further methods of interaction between content providers and consumers.

What is needed, therefore, is a system and method of providing a broadband information appliance,

### SUMMARY OF THE INVENTION

An information appliance includes a network connection, a telecommunications processor connected to the network connection to provide two-way communication and a video processor connected to the network connection. An optical reader is connected to the network connection. A request signal is sent to a server via the network connection in response to the optical reader reading a code.

An associated provider sends content to said information appliance in response to the received request signal. A system for providing on-screen management of content delivery to an audio-video telecommunications terminal including a network connection, a telecommunications processor connected to the network connection and a video processor connected to the network connection. A display on the telecommunications terminal is connected to the video processor. The display provides visual displays for programming the delivery of content to the video processor via the network.

A method of delivering content to an A/V telecommunication device in response to a scanned code is performed by reading a machine readable code and sending a signal to a host server in response to the read code. The A/V telecommunication device receives content from a content provider in response to the signal sent to the host server.

A method of providing messages on an A/V telecommunication system recognizes an unanswered A/V communication. Recorded A/V content is sent to a calling A/V telecommunication device. A/V message content is recorded from the calling A/V telecommunication device. When a request for messages is received, recorded A/V content is sent to a called A/V telecommunication device and then recorded A/V message content is sent.

An information appliance having a network connection, a telecommunications processor connected to the network connection and a video processor connected to the network connection includes a transceiver connected to said telecommunication processor and a wireless handset communicably connected to said transceiver.

An information appliance including a network connection, a telecommunications processor connected to the network connection, and a video processor connected to the network connection includes a wireless transceiver connected to said video processor and a digital image device communicably connected to said wireless transceiver.

An information appliance including a network connection, a telecommunications processor connected to the network connection, and a video processor connected to the network connection includes a housing which contains the telecommunication processor and the video processor. A video display holder is connected to the housing. A video display interface is connected to the video processor. A video display unit may be connected to the video display interface and attached to the video display holder.

An information appliance including a network connection, a telecommunications processor connected to the network connection, and a video processor connected to the network connection may further include a digital camera connected to said video processor.

An information appliance including a network connection, a telecommunications processor connected to the network connection, and a video processor connected to the network connection includes a display connected to said video processor and an optical scanner communicably connected to said video processor. When the optical scanner scans an optical code, the display is activated.

A method of caller identification on an A/V telecommunication device having a network connection, a telecommunications processor connected to the network connection and a video processor connected to the network connection may be performed by receiving caller identification information with an incoming call, retrieving an image file associated with the caller information and displaying the image file on the A/V telecommunication device.

A method of caller identification in an A/V telecommunication system including a host server with a host server memory communicably connected to an A/V telecommunication device may be performed by detecting by the host server of an incoming call from a source to an A/V telecommunication device. The host server receives source information regarding the source and retrieves identification data associated with the source information by the host server. Identification data is sent to said AN telecommunication device by the host server.

An A/V telecommunication device including a network connection, a telecommunications processor connected to the network connection, a video processor connected to the network connection may include an integrated network radio receiver communicably connected to the network connection to receive network radio broadcast signals over the network.

An A/V telecommunication device including a network connection, a telecommunications processor connected to the network connection and a video processor connected to the network connection may include an integrated coupon server communicably connected to the network connection and a printer communicably connected to the coupon server.

An A/V telecommunication device including a network connection, a telecommunications processor connected to the network connection, and a video processor connected to the network connection may include an integrated optical scanner communicably connected to the telecommunications processor.

An information appliance including a network connection, a telecommunications processor connected to the network connection and a video processor connected to the network connection may include an integrated video camera communicably connected to the video processor.

An A/V telecommunication terminal including a network connection, a telecommunications processor connected to the network connection and a video processor connected to the network connection may include an integrated VOIP multimedia terminal adapter.

An A/V telecommunication device including a network connection; a telecommunications processor connected to the network connection; a video processor connected to the network connection may include a digital jukebox communicably connected to the network.

An A/V telecommunication device including a network connection, a telecommunications processor connected to the network connection, and a video processor connected to the network connection may include an integrated resource management organizer communicably connected to the video processor.

An A/V telecommunication device including a network connection, a telecommunications processor connected to the network connection, and a video processor connected to the network connection may include an integrated ticket server.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a household broadband information appliance;

FIG. 1A illustrates a handset for a household broadband information appliance;

FIG. 2 illustrates a block diagram of a household broadband information appliance;

FIG. 3 illustrates a block diagram of a household broadband information appliance;

FIG. 4 illustrates an optical command telecommunications system;

FIG. 5 illustrates a flowchart of a process for managing the delivery of content with an on-screen menu;

FIG. 6 illustrates a system for delivering content to a A/V telecommunication device in response to a scanned code;

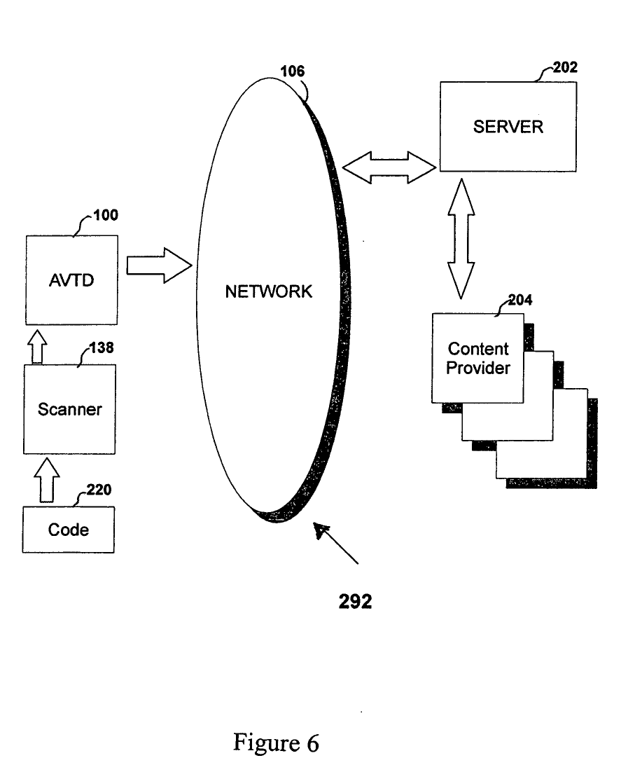

FIG. 7 illustrates a system for providing A/V answering messages;

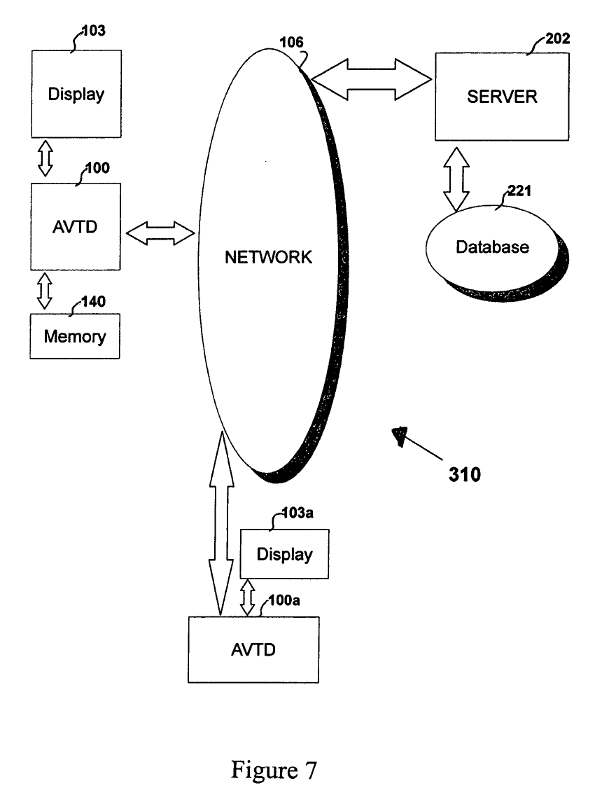

FIG. 8 illustrates a flowchart of a process for providing A/V answering messages;

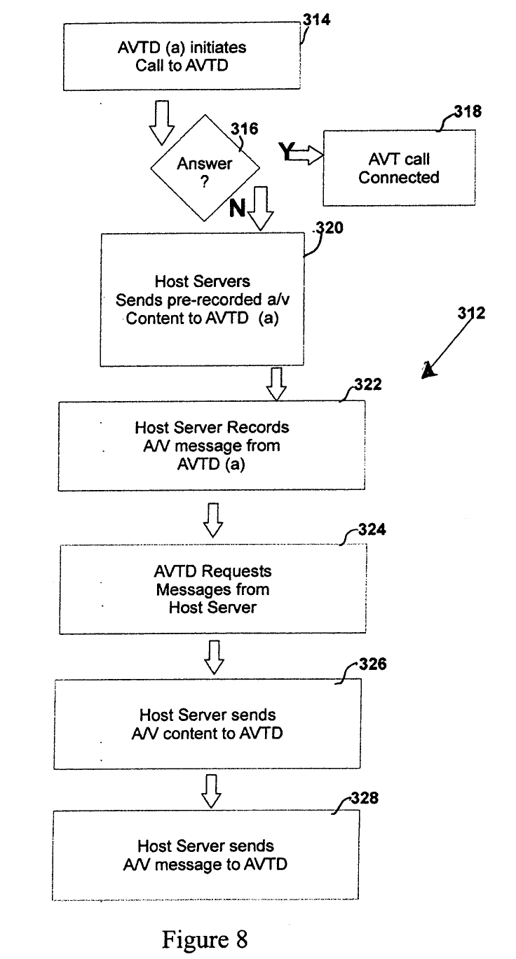

FIG. 9 illustrates a wireless handset;

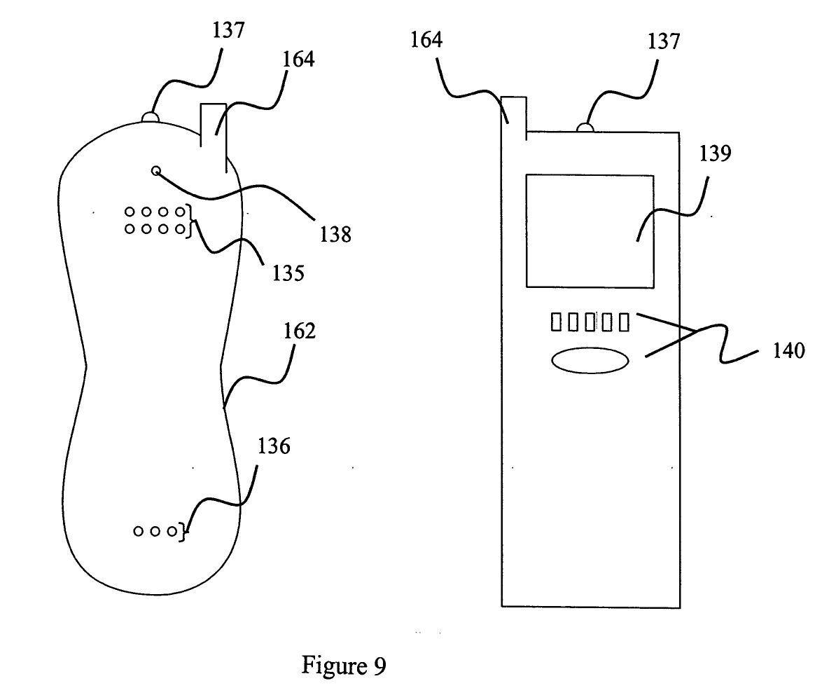

FIG. 10 illustrates an AW telecommunication system including a wireless camera;

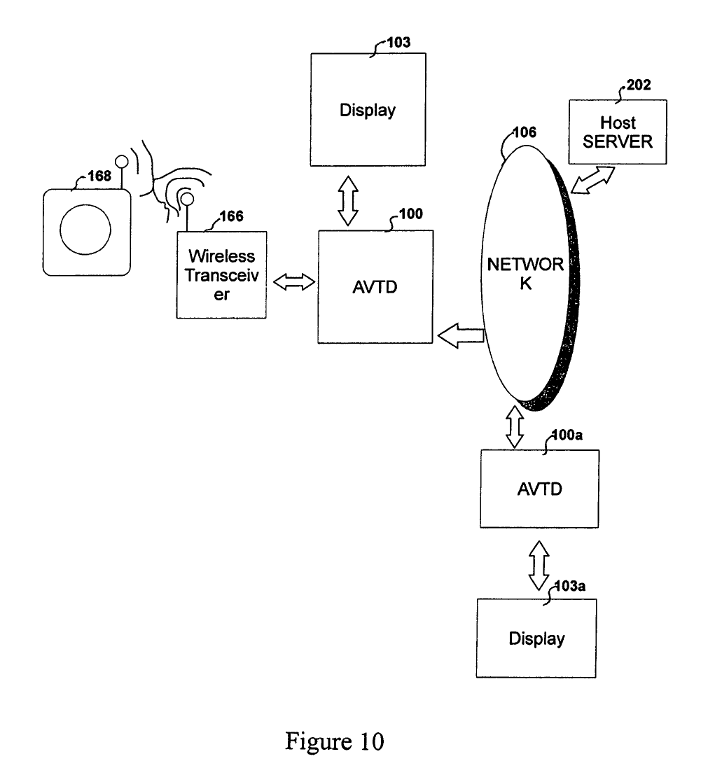

FIG. 11 illustrates an interchangeable video display unit;

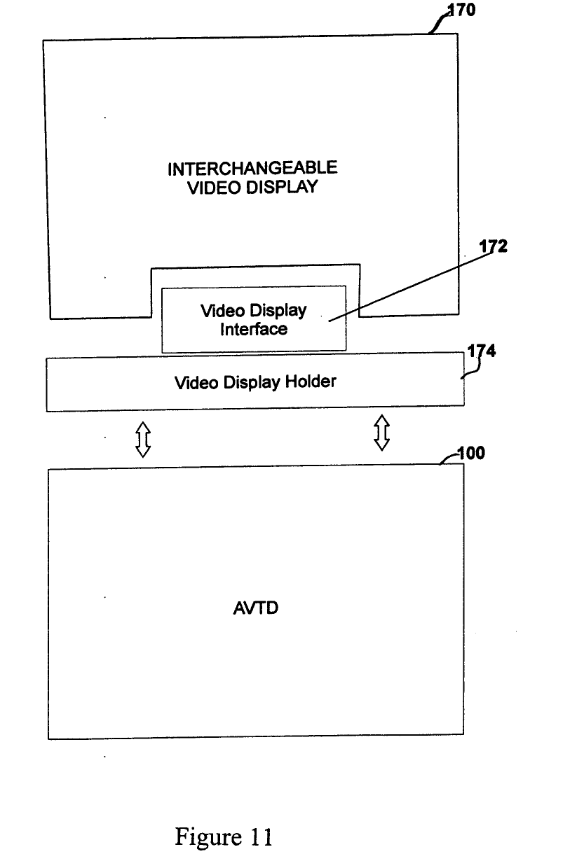

FIG. 12 illustrates an A/V telecommunication device with a digital camera;

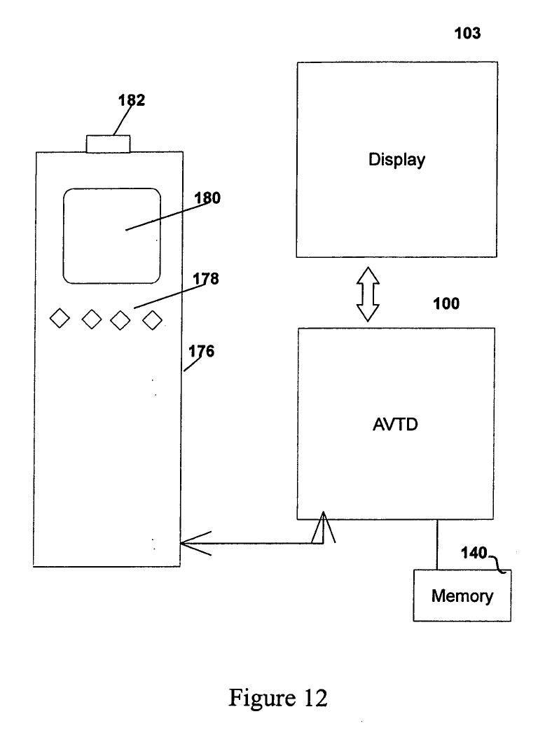

FIG. 13 illustrates a code-activated display in an A/V telecommunication device;

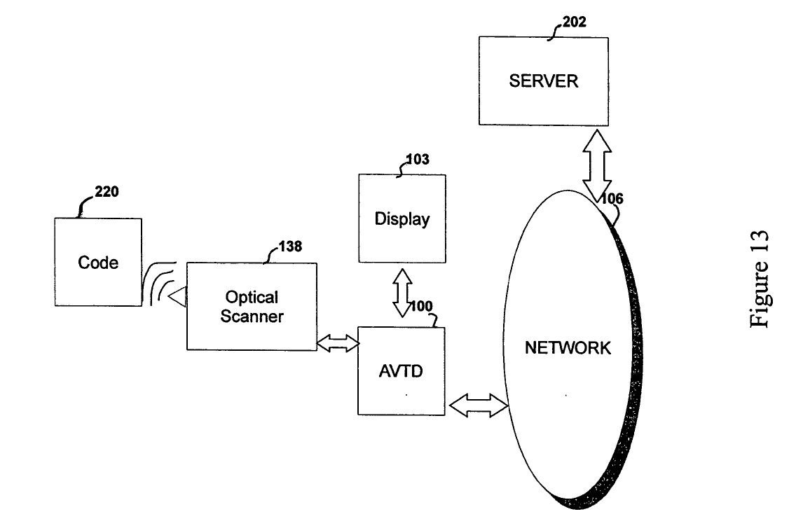

FIG. 14 illustrates a system for caller identification;

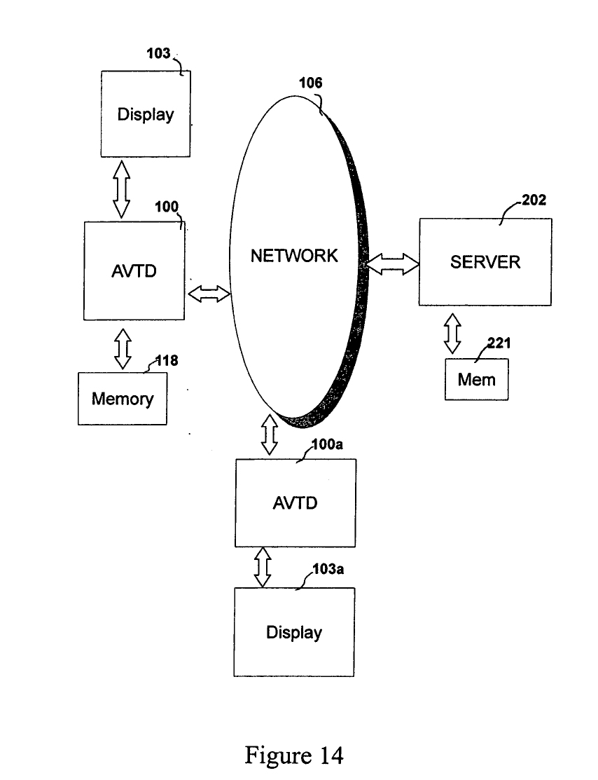

FIG. 15 illustrates a caller identification system;

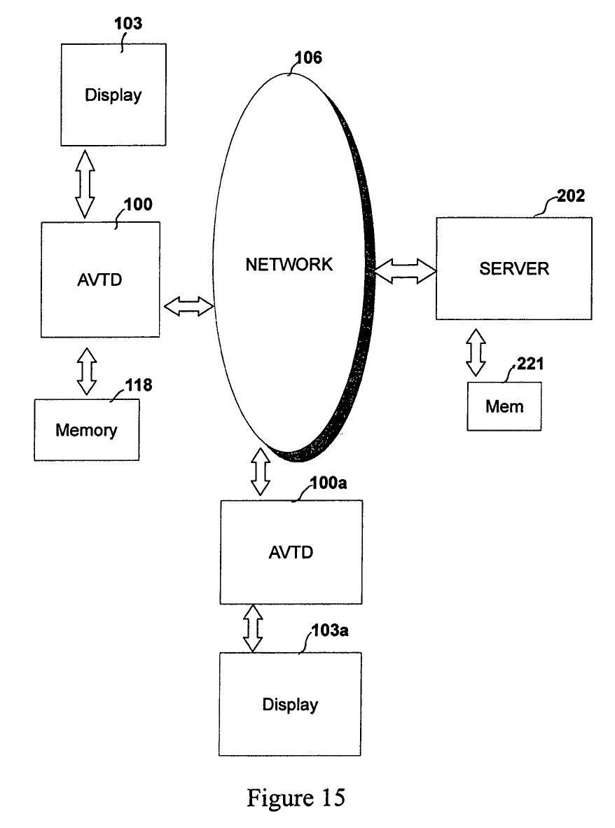

FIG. 16 illustrates an A/V telecommunication device with an integrated network radio receiver;

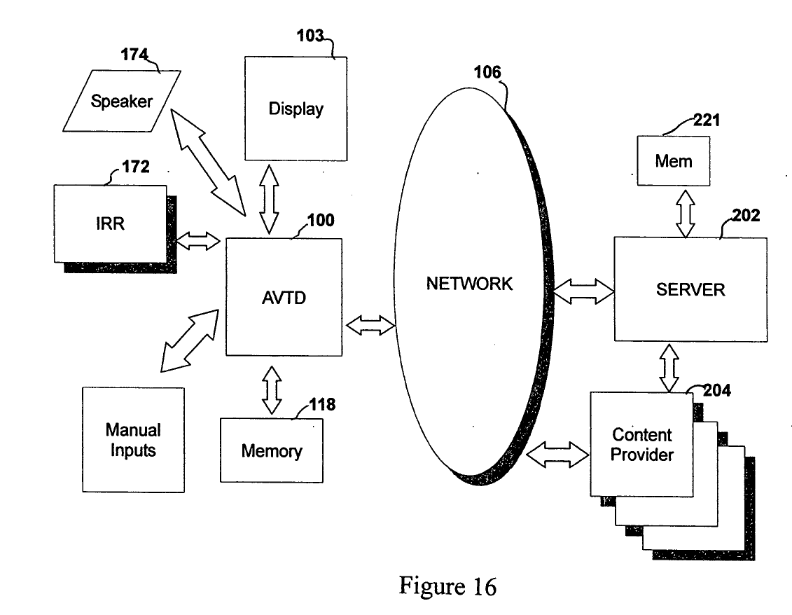

FIG. 17 illustrates an AVTD including an integrated coupon server;

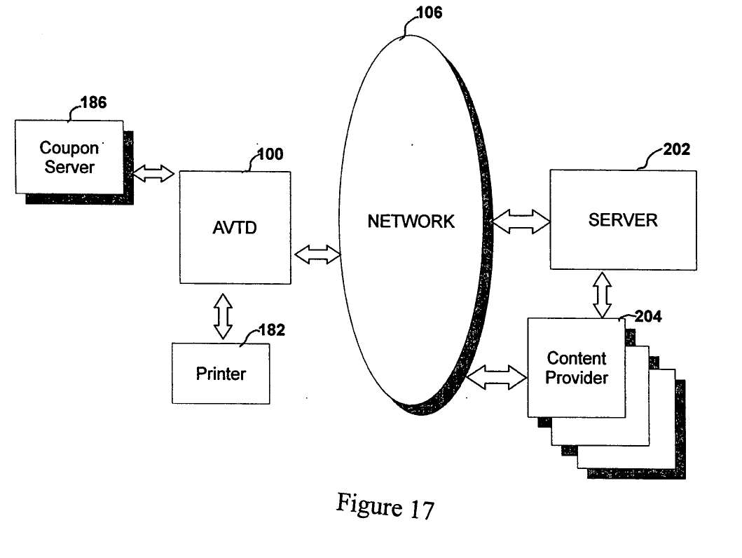

FIG. 18 illustrates an integrated scanner;

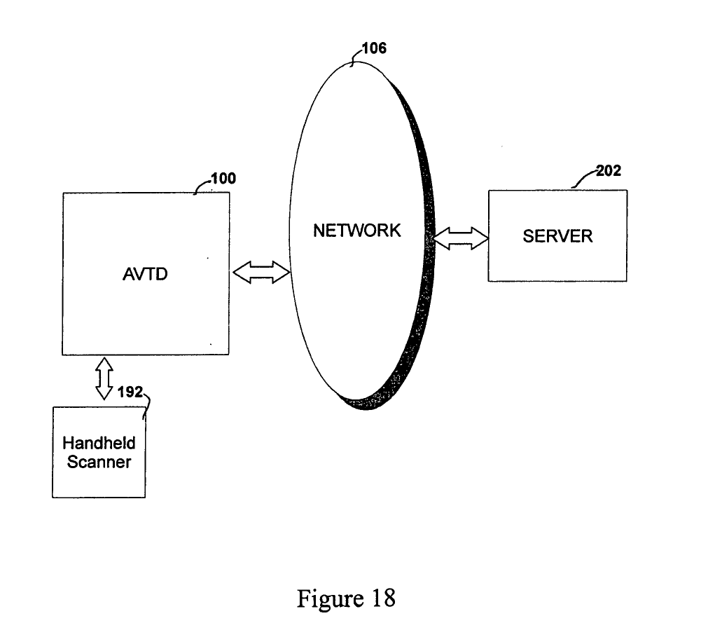

FIG. 19 illustrates an integrated video camera;

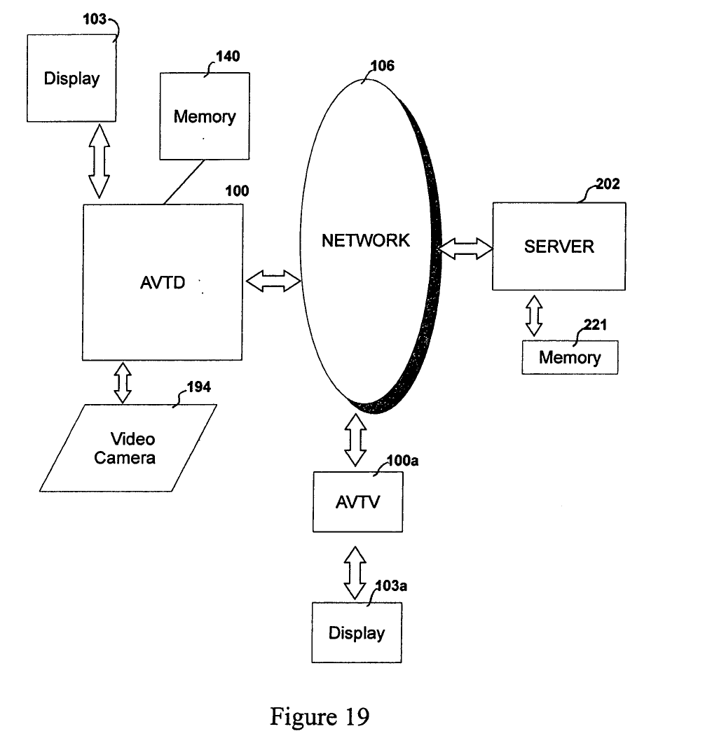

FIG. 20 illustrates an AVTD with an integrated VOIP multimedia adapter;

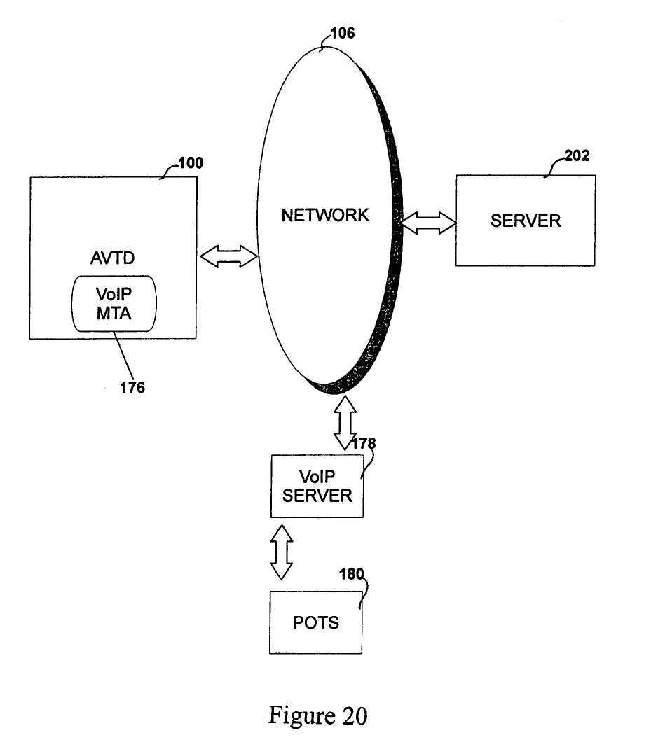

FIG. 21 illustrates an integrated digital jukebox;

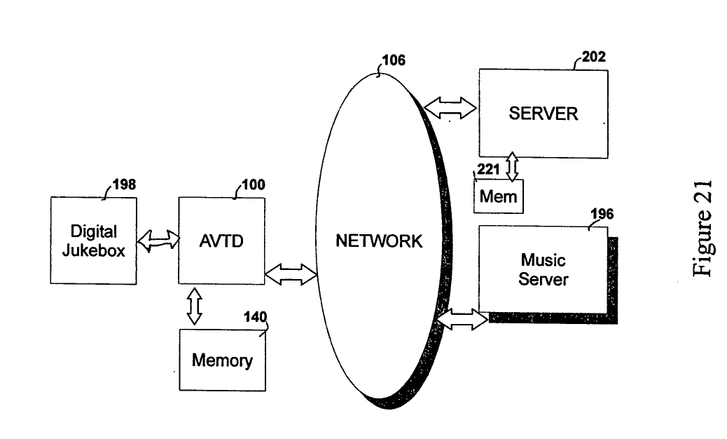

FIG. 22 illustrates an integrated resource management organizer; and

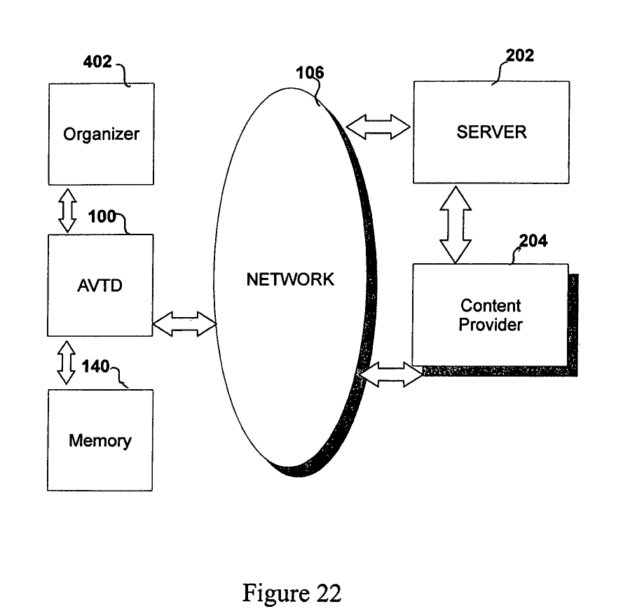

FIG. 23 illustrates a A/V telecommunication device having an integrated ticket server.

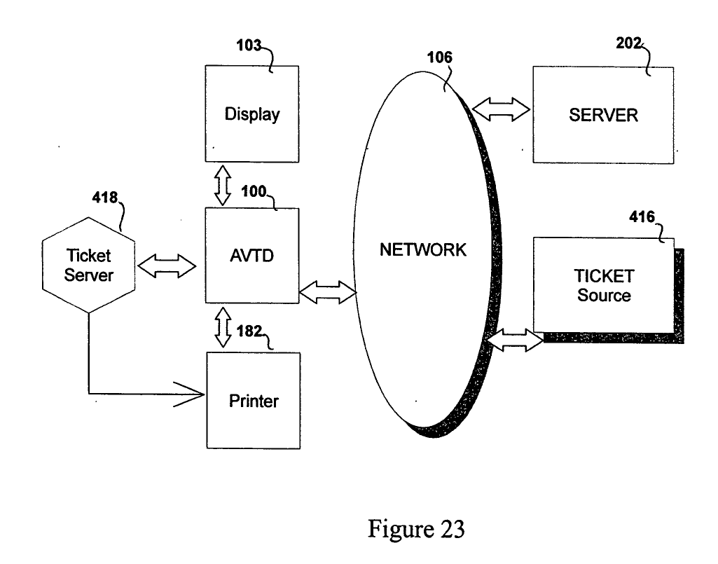

### DETAILED DESCRIPTION OF THE INVENTION

Referring now to the drawings, wherein like reference numbers are used to designate like elements throughout the various views, several embodiments of the present invention are farther described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

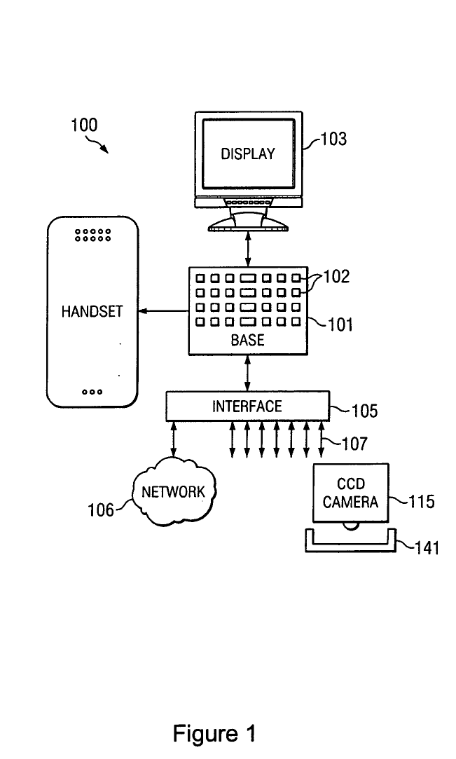

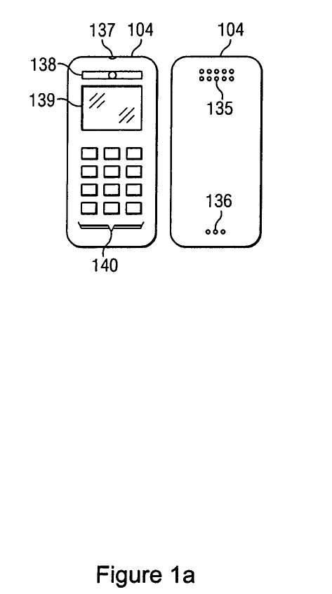

With reference to FIG. 1, a functional depiction of a broadband information appliance 100 is shown. The broadband information appliance 100 includes a base unit 101. The base unit 101 typically houses the processing circuits, memory storage, interfaces 105, manual inputs 102 and power connections. The base unit 101 may be attached to a display 103. The display 103 may be integral with the base unit 101. The display 103 may be an independent unit fixedly attached to the base unit 101. The display 103 may be interchangeably attached to the base unit 101 such that the display 103 may be easily exchanged for a different display 103.

Base unit 101 may include manual inputs 102. Typically the manual inputs 102 may include a standard telephone keypad with ten numeric buttons plus “#” and “*” buttons. The manual inputs 102 may further include any number of other buttons, switches, thumbwheels or other appropriate manual input devices. A wide variety of functions and features may be controlled using the manual inputs 102. Manual inputs 102 may include navigation keys or a joystick for up, down, right and left selections, programmable soft keys. Power and status LEDs may also be provided.

Base unit 101 may be connected to a handset 104. Handset 104 may be substantially a standard telephone handset including a microphone and speaker. Handset 104 may be directly connected to the base unit 101. A handset 104 directly connected to the base unit 101 may be called a “tethered” or “wired” handset. Handset 104 may also include a wireless transceiver for wireless connection to a base unit including (or connected to) a wireless transceiver. The wireless transceivers may be a 2.4 gigahertz transceivers or may use any other suitable wireless transceiver frequency. The wireless transceivers may be spread spectrum transceivers. A handset 104 wirelessly connected to the base unit may be called a “wireless” handset.

Base unit 101 may be connected to an interface 105. Typically, interface 105 will be integral with base unit 101. Interface 105 includes an interface for connection to network 106. Network 106 may be an open network such as the Internet. Interface 105 includes interface connections 107 for connecting the base unit 101 to a variety of peripherals or networks. Typically, the interface 105 will provide Ethernet ports, telephone handset and keypad support, video capture and display ports including NTSC composite input and output ports, S-video ports, NTSC camera ports and LCD display ports. The interface 105 may include audio capture and reproduction ports, an external microphone port, an external speaker port, two audio line level inputs, a handsfree speakerphone,

A digital video camera 115 may be connected to base unit 101. Typically digital video camera 1105 is a CCD camera device. The digital video camera 115 may be integral with the base unit 101 or the display 103. An additional digital video camera 137 may be integral with the handset 104. A privacy shield 141 may be a cover provided to disable the digital video camera 137 by covering the lens of the digital video camera 137.

With reference to FIG. 1A, a more detailed depiction of the features that may be incorporated into handset 104 is shown. The handset 104 typically includes a speaker 135 and a microphone 136 to provide standard audio communication. Handset 104 may include a digital video camera 137, typically at one end of the handset 104. A scanner 138 may be provided on the handset 104 to read machine readable codes or to scan image data. An LCD display 139 may be provided on the handset 104 to allow the user to see the input from digital video camera 137, show video data being shown on display 103 when the handset 104 is being used remotely from the base 101. The handset display 139 may also show alternate visual data. The handset 104 may include further manual inputs 140 to control the video camera 137, handset display 139, scanner 138.

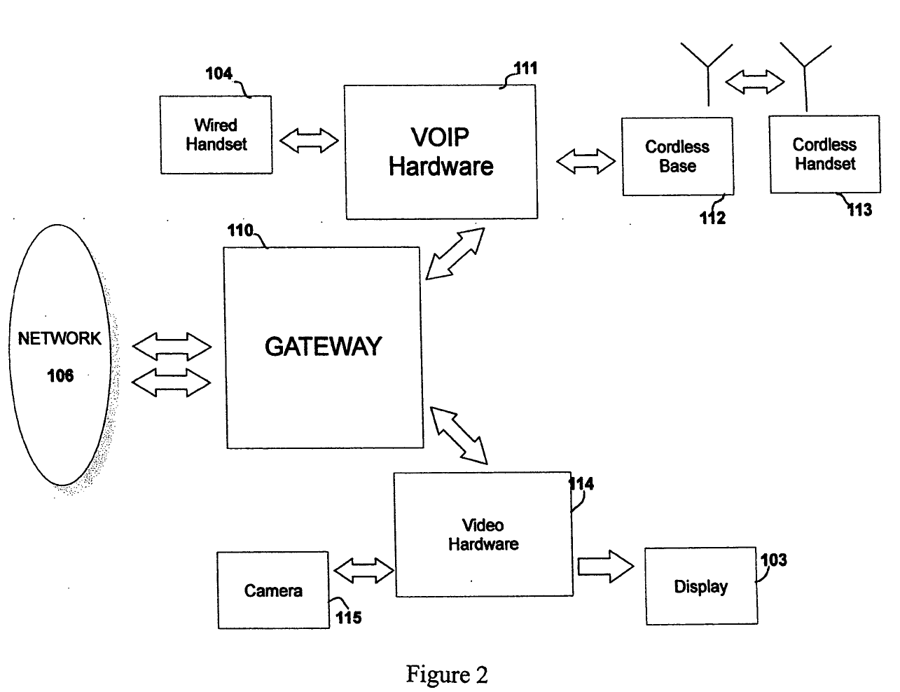

With reference to FIG. 2, a functional block diagram of a basic broadband information appliance 100 is shown. A gateway 110 provides an interface to network 106. The gateway communicates with voice-over-internet-protocol (VOIP) hardware 111 and video hardware 114. The VOIP hardware 114 may be directly connected to wired handset 104 or may be connected to a cordless base unit 112 which provides wireless communication with a cordless handset 113, The video hardware 114 may be connected to a video camera 115 and a display 103,

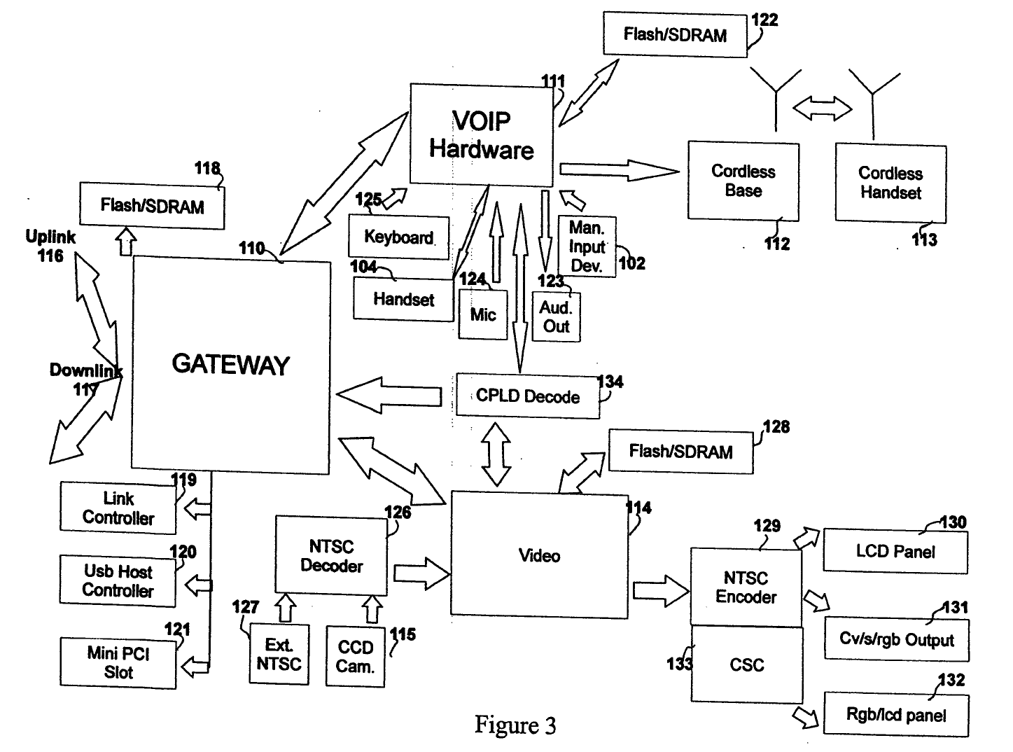

With reference to FIG. 3, a more detailed functional block diagram of a broadband information appliance 100 is shown. A gateway 110 provides communication with one or more networks 106. Gateway 110 may be a Micrel KS8695P processor. The gateway 110 typically acts as the master boot processor for the broadband information appliance 100. The gateway 110 is typically an integrated, multi-port PCI bridge system on a chip. The KS8695P integrates an ARM922T CPU, a PCI bridge that can support up to 3 external PCI masters and a 5-port switch with integrated media access controllers and low power Ethernet PHYs. The PCI interface can be connected gluelessly to miniPCI or cardbus wireless LAN cards that support 802.1 la/g/b. Those skilled in the art will recognize that other processors, chips or configurations could be used for the gateway 110.

The KS8695P gateway processor includes five Ethernet MAC and PHY, 10/100 Base-Transceivers. It includes a PCI bridge and Master arbiter of up to 3 external PCI 2.1 compliant controllers, supporting a 32 bit data bus as 33 MHz clock speed. The processor includes a memory controller for glueless synchronous DRAM support at 133 MHz access of up to 32 MB. The processor has a standard memory bus for SRAM and flash ROM, 32 bit address, 32 bit data up to 32 MB, with general purpose I/O pins and a JTAG port.

Gateway 110 provides one or more external Ethernet ports. Gateway 110 includes Ethernet ports for both uplink 116 and downlink 117 connections. Typically, uplink 116 and downlink 117 are integrated, however according to some embodiments, separate communication links may be provided for the uplink 116 and downlink 117, particularly where bandwidth limitations make it advisable to provide greater bandwidth for the downlink 117 than the uplink 116.

Gateway 119 may be connected to a link controller 119, a USB host controller 120, a mini-PCI slot 121 or other interfaces. Gateway 119 may be connected to gateway memory 118-Gateway memory 118 may be flash memory, SDRAM or other suitable memory device,

Gateway 119 may be connected to a VOIP processor 111. A VOIP processor 111 is a communication processor for audio codec and telephone management. The VOIP processor 11 may be a Telogy TNETV1050 DSP. The VOIP processor may include a MIPS32 reduced instruction set computer processor and a C55 DSP. The RISC processor software supplies overall system services and performs user interface, network management, protocol stack management, call processing and task scheduling functions. The DSP software provides real-time voice processing functions such as echo cancellation, compression, pulse-code modulation data processing and tone generation and detection.

Two 10/100 Base-T Ethernet MAC and PHY are included with integrated layer-2 three-port Ethernet switches. On-chip peripherals include an 8×8 keypad interface, USB controller host, universal asynchronous receiver/transmitter serial interface, a programmable serial port, several general-purpose input/outputs and integrated voltage regulator.

The integrated dual channel 16-bit voice coder/decoder integrates the critical functions needed for IP phone applications, including two analog-to-digital converters and two digital to analog converters. Other features include analog and digital sidetone control, filter, programmable gain options, a programmable sampling rate, 8-speaker driver, microphone, handset and headset interfaces.

The VOIP processor 111 may include dual Ethernet MAC and PHY, 10/100 base transceivers. The VOIP processor 111 may include a speaker and microphone for handset, headset, and optional input and output sources. The VOIP processor 111 may include a PC and Palm compatible IrDA transceiver, a RS-232 serial port, a USB host port, general purpose I/O pins for LED and configuration options. The VOIP processor 111 may include synchronous DRAM, 133 MHz up to 128 MB, a standard memory bus, a JTAG port and HP Logic analyzer connectors. Those skilled in the art will recognize that other VOIP processors may be used as suitable.

VOIP processor 111 may be connected to a VOIP memory 112. VOIP memory 112 may be a flash memory, SDRAM or other suitable memory devices. The VOIP hardware 111 may be connected to a handset 104 or a cordless base 112 which provides wireless communication with a cordless handset 113. The VOIP hardware 111 may be connected to manual input devices 102>> a microphone 124, a speaker 123. VOIP hardware 111 may be connected to an alpha-numeric keyboard 125.

Gateway 110 may be connected to video processor 114. The video processor 114 is a video codec and LCD panel controller. The VOIP processor 111 may be a TI TMS320DM642 digital signal processor. The digital signal processor may be based on the second-generation high-performance advanced VelociTI very-long-word-instruction (VLIW) architecture. The digital signal processor may provide 4800 million instructions per second at a clock rate of 600 MHz. The DSP offers operational flexibility of high speed controllers and the numerical capability of array processors. A DSP core processor has 64 general purpose registers of 32-bit word length and eight independent functional units including two multipliers for 32 bit word length and six arithmetic logic units. The DSP provides extensions in the eight functional units including new instructions to accelerate performance in video and imaging applications to extend parallelism. The DSP can produce four 32-bit multiply accumulates per cycle for a total of 2400 million MACs per second or eight 8-bit MACs per cycle for a total of 4800 million MACs. The DSP may have application specific hardware logic, on-chip memory and additional on-chip peripherals.

The DSP typically uses a two-level cache-based architecture. A Level 1 program cache is a 128-Kbit direct mapped cache and a Level 1 data cache is a 128-K.bit 2-way set-associative cache. A Level 2 memory cache consists of a 2-Mbit-memory space that is shared between program and data space. Level 2 memory can be configured as mapped memory.

The peripheral set may include configurable video ports; a 10/100 Mb/s Ethernet MAC; a management data input/output; a VCXO interpolated control port; a multichannel buffered audio serial port; an inter-integrated circuit bus module; two multichannel buffered serial ports; three 32-bit general purpose timers; a user-configurable 16-bit or 32-bit host port interface; a peripheral component interconnect; a 16-ping general-purpose input/output port with programmable interrupt/even generation modes; and a 64-bit glueless external memory interface which is capable of interfacing to synchronous and asynchronous memories and peripherals.

The DSP may have three configurable video port peripherals. These video port peripherals provide a glueless interface to common video decoder and encoder devices. The DSP video port peripherals support multiple resolutions and video standards. The video ports peripherals are configurable and can support video capture and video display modes. Each video port may include two channels with a 5120 byte capture/display buffer that is split-able between the two channels.

The DSP may include three video ports including a capture port interfaced with a Philips SAA7115 decoder with integrated multiplexer for NTSC, S-video sources; display port interfaced with Philips SAA7105 NTSC and S-video encoder and a third port dedicated to an LCD panel. The DSP may include Ethernet MAC 10/100 Base-Transceivers. The DSP may include general purpose I/O pins and a JTAG port. The DSP may be a synchronous DRAM 64-bit wide, 133 MHz up to 1 GB support. The DSP may include a standard asynchronous memory bus 32 bit. The DSP may include HP logic analyzer connectors for memory bus address, data and control signals. Those skilled in the art will recognize that other DSP processors may be implemented.

The video processor 114 may be connected to a video memory 128. Video memory 128 may be a flash memory, SDRAM or other suitable memory device. The video processor 114 may be connected to a video decoder 126. Video decoder 126 may be a NTSC decoder. Video decoder 126 may receive video signals from an external source 127 or a video camera 115. The video processor 114 may be connected to a video encoder 129. The video encoder 129 may be an NTSC encoder. The video encoder 129 may be integral with a CSC 133 to provide video signals to an RGB/LCD panel 132. The video encoder 129 may provide video signals to an LCD panel 130 and a CV/S/RGB output.

The gateway 110, VOIP processor 111 and video processor 114 may be mutually connected to a CPLD decoder 134.

The broadband information appliance 100 may include smart media access, an infrared transceiver, an unpowered firewire port, fast peripheral ports, a wireless interface, Bluetooth support and a HomePlug interface.

The broadband information appliance 100 may be an AC powered device, using residential power distribution of 120 VAC at 60 Hz or 230 VAC at 50 Hz. A power adapter may convert the AC power to 12 volts DC.

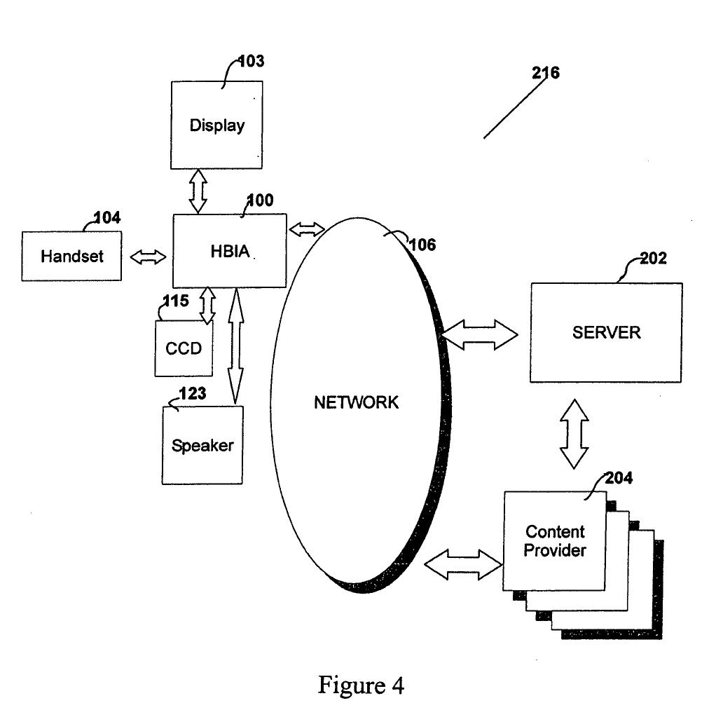

With reference to FIG. 4, an optical command telecommunications system 218 is shown. An HBIA 100 is connected to an optical reader 138. The optical reader 138 is typically integrated in the handset 104, but may be provided as a separate device. The optical reader 138 is used to read machine-readable code 220 such as a bar code. The HBIA 100 is connected to a network 106. When the optical reader 138 reads the code 220, a signal is sent from the HBIA 100 to the host server 202. The server 202 may find an associated provider 222 by cross-referencing the signal sent from the HBIA 100 in a relational database 221. The associated provider 222 is connected to the HBIA 100 via the network 106. Media may be provided by a content provider 204.

The broadband information appliance typically includes three memory module, particularly the gateway memory 118, the VOIP memory 122 and the video memory 128. SDRAM memory may be connected through each of the direct SDRAM interfaces in the DSP and gateway processors. SDRAM may be rated to operate at 133 MHz and terminated with discrete components. Dedicated SDRAM for each processor may be used.

With reference to FIG. 4, a flowchart of an on-screen information management system for an A/V telecommunications terminal 244 is shown. The display 103 of the telecommunications terminal 100 provides a visual menu to a user at function block 246. The visual menu may include audio content. The visual menu offers the user a selection of content or other options regarding the programming, scheduling or management of the content. The user selects content at function block 248. The user typically selects content by means of a touch-screen display 103 or physical keys 102 associated with visual cues to content.

The user may program the delivery of content at function block 250 by selecting one or more programming parameters. The user may schedule the delivery of content at function block 252 by selecting one or more scheduling parameters. The user may manage the delivery of content at function block 254 by selecting one or more management parameters. The telecommunications terminal 100 sends commands via the network 106 to the host server 202 at function block 256. The server 202 acknowledges the commands at function block 258. The host server 202 sets parameter regarding the delivery of content in accordance with the A/V telecommunication terminal commands at function block 260.

With reference to FIG. 4, a system for using code inputs to direct content 292 is shown. The A/V telecommunication device 100 is connected to an optical scanner 138. The optical scanner 138 may be integral with handset 104 or may be attached to the A/V telecommunication device as a peripheral. The optical scanner 138 may be designed specifically to read machine-readable codes such as a bar code 220. When the optical scanner 138 reads a bar code 220, a signal is sent to host server 202 via network 106. In response to the received signal, the host server 202 may deliver content from content provider 204 to A/V telecommunication device 100. The host server 202 may create a two-way A/V telecommunication session between the A/V telecommunication device and a content provider 204.

With reference to FIG. 4, an A/V telecommunication system 310 for providing interactive audio/visual answering messages for an A/V telecommunication device 100. An A/V telecommunication device 100 including a display 103 and memory 140 is connected to a network 106. The communication with A/V telecommunication device 100 may be initiated by entering the address (telephone number, IP address, URL, etc.) of the A/V telecommunication device 100 at a second AVTD 100a with a display 103a. A host server 202 is connected to the network 106 and typically controls, manages or otherwise communicates with the AVTD 100. Host server 202 may include memory 221.

When ATVD 100a initiates communication with ATVD 100 by entering an address for ATVD 100, an incoming call notification, such as a telephone ring, is played or displayed at ATVD 100. A user may accept the incoming call by lifting a handset, activating a connect button or some other designated answering action. Where the user is unavailable or unwilling to accept the incoming call, the calling ATVD 100a is sent an audio/visual message that has been pre-recorded for this purpose. The audio/visual message typically instructs the caller to record a message or take other action. The audio/visual message may include promotional material such as an A/V commercial. When the caller is prompted to leave a message, the message is recorded and stored for playback by the user of AVTD 100. The audio/visual message and the caller message may be stored at the AVTD local memory 140 or the server memory 221.

When the user at AVTD 100 is ready to retrieve messages, the user sends a command sequence by pressing one or more buttons or any other input method. The command sequence may initiate the playback of another audio/visual message to introduce the messages. Further command sequences may be used to control playback of the messages.

Because the host server 202 is aware of the presence of messages, the host server 202 can collect data regarding the number of times the promotional messages have been played by consumers. This permits advertisers to monitor the saturation of their A/V messages with exact, real-time accuracy.

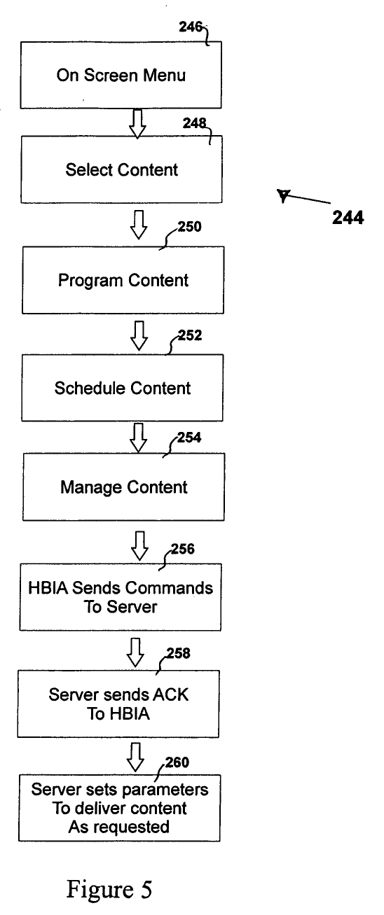

With reference to FIG. 5, a flowchart of the A/V message process 312. An ATVD 100a initiates a call to AVTD 100 at function block 314. The system checks to see if the call has been answered at decision block 316. If the call is answered, the process follows the YES path to function block 318 where the call is connected. If the call is not answered, the process follows the NO path to function block 320 where the host sends pre-recorded A/V content to the calling AVTD 100a. The process continues at function block 322 where the host server 202 records an A/V message from AVTD 100a.

A caller at AVTD 100 requests messages from the server 202 at function block 324. The host server 202 sends pre-recorded A/V content to the AVTD 100. The host server 202 then sends the recorded A/V message to the AVTD 100.

With reference to FIG. 4, a wireless handset 162 for use with an A/V telecommunication device 100 is shown. A wireless handset 162 is communicably connected to the A/V telecommunication device 100 by means of mutual transceivers. An antenna 164 may be used to transmit and receive the relevant radio signals. As with the tethered handset 104, the wireless handset 162 may include a speaker 135 and a microphone 136. An optical scanner 138 and a digital camera 137 may be integral to the wireless handset 162. A display 139 may be built into the back of the handset 162. Manual input buttons 140 may be used to provide controls.

With reference to FIG. 4, an A/V telecommunication system with a wireless video camera 168 is shown. A/V telecommunication device 100 includes a display 103 and an integral wireless transceiver 166. The wireless transceiver 166 communicates with wireless digital camera 168. The digital images captured by video camera 168 may be displayed on local display 103 or may be communicated to a remote display 103 a via a communication established with server 202 to remote AVTD 100a.

With reference to FIG. 4, an interchangeable video display for an A/V telecommunication device 100 is shown. A/V telecommunication device 100 may be integral with a standardized video display holder 174. Standardized video display holder 174 may be fashioned to hold a variety of video display units 170 in place on the A/V telecommunication device 100. A/V telecommunication device 100 may include a standardized video display interface 172. Standardized video display interface 172 may be fashioned to communicably connect with a variety of video display units 170.

Video display unit 170 may be snapped into video display holder 174 and video display interface 172 so that video information from A/V telecommunication device 100 may be communicated to video display unit 170. A variety of different video display units may be easily interchanged, allowing users to customize their A/V telecommunication device 100 with a video display unit 170 that satisfies their idiosyncratic needs.

With reference to FIG. 4, an A/V telecommunication device 100 with an integral digital camera 176 is shown. A/V telecommunication device 100 may include a display 103 and memory 140. A/V telecommunication device 100 may include a digital camera 176 including a lens 182, display 180 and manual inputs 178. The digital camera 176 may be physically integrated into the housing of the A/V telecommunication device 100. The digital camera 176 may be connected to A/V telecommunication device 100 by a wire or cable. The digital camera 176 may be communicably connected to A/V telecommunication device 100 by a pair of transceivers. Image data collected by the digital camera 176 may be displayed on display 103, saved in memory 140 or transmitted via network 106 to another AVTD 100a or storage.

With reference to FIG. 4, an A/V telecommunication system including a code-controlled display 103 is shown. A/V telecommunication device 100 includes a display 103 and an optical scanner 138. Optical scanner 138 is a bar-code-reader or similar device for reading machine-readable code 220. Other forms of input, including manual inputs to keys, may be used. When a machine-readable code 220 is scanned by optical scanner 138, display 103 is activated. In being activated, the display 103 may be powered. The images being displayed on display 103 may be interrupted as a result of the input of the code 220. Typically, the input of code 220 will also establish communication with server 202 via network 106 so that image data is sent to display 103. Other forms of response may be implemented.

With reference to FIG. 4, an A/V telecommunication device 100 including digital video caller identification functions is shown. A/V telecommunication device 100 includes a display 103 and a memory 118. The A/V telecommunication device 100 is connected to a network 106. A host server 202 with memory 221 is connected to network 106. Other A/V telecommunication devices 100a including displays 103a are also connected to network 106. When an A/V telecommunication device 100a initiates a connection with A/V telecommunication device 100, a signal identifying A/V telecommunication device 100a to A/V telecommunication device 100. In response to the identifying signal, a pre-selected image display of the caller is shown on display 103 of AV telecommunication device 100, to identify the caller to the callee. The image could be supplied by the caller's AVTD 100a, either at an earlier time and synchronously with the initiation signals. The image may be selected and associated with the caller/source. The selected image may be downloaded, scanned or otherwise input to the A/V telecommunication device 100.

With reference to FIG. 4, an A/V telecommunications device 100 with caller identification is shown. A/V telecommunication device 100 has a display 103 and memory 118. The A/V telecommunication device 100 is communicably connected to a network, such as the Internet. A host server 202 with memory 221 is communicably connected to the A/V telecommunication device 100 via the network 106. When an incoming call from a source 160 for A/V telecommunication device 100 is detected by the server 202, the server 202 detects information regarding the source 160 in the communication and refers to a database in memory 221 to associate caller identification data with the source 160. The caller identification information is sent to the A/V telecommunication device 100 via the network 106 from the server 202. The caller identification information may include the originating phone number, IP address, name, or any other pertinent information. A/V files may be associated with the source 160, such that, for example, an audio file associated with a caller may be played at A/V telecommunication device 100 when an incoming call is detected, identifying the caller by the sound of their voice or other distinguishable characteristics.

With reference to FIG. 4, an A/V telecommunications device 100 with an integrated network radio receiver 172 is shown. An A/V telecommunications device 100 may include a display 103, memory 118 and inputs, including manual inputs 102. In response to an input or sequence of inputs, such as an IP address, telephone number, etc., a request for connection to a media provider 204, such as an Internet radio provider, is sent to a host server 202 with memory 221. The host server 202 may refer to a database in memory 221 to identify any necessary address associations to establish the connection with content provider 204. Content provider 204 sends media content, such as a streaming audio signal, to the A/V telecommunications device 100 with an integrated network radio receiver 172. The streaming audio is converted into analog signals to drive a speaker 174 of A/V telecommunication device 100.

With reference to FIG. 4, an A/V telecommunication device 100 having an integrated coupon server 186 is shown. The A/V telecommunication device 100 may be connected to a printer 182. The printer 182 may be used to print coupons, tickets or other paper tokens. The coupon server 186 may include processing systems for encoding, encrypting, authenticating the coupon data files. A coupon may be sent to an A/V telecommunication device 100 automatically, in response to a condition or user input, or under other conditions. The coupon data file originates with a content provider 204. The coupon data file may be communicated to the A/V telecommunications device via network 106, such as the Internet. The coupon data file may be requested by a host server 202 in communicable connection with A/V telecommunication device 100 over network 106. The coupon data file may be communicated through the host server 202 or directly. The event may be catalogued by the host server 202.

With reference to FIG. 4, an A/V telecommunication device 100 with an integrated scanner 192 is shown. Integrated scanner 192 may typically a hand-held scanner. The scanner 192 may be integrated with the handset 104. The scanner 192 may be fixed in the housing of the A/V telecommunication device 100. The scanner 192 may be used to read machine-readable code. The scanner 192 may be used to input graphic data to the A/V telecommunication device for local use or for transmission via the server 202 on network 106.

With reference to FIG. 4, an A/V telecommunication device 100 having an integrated video camera 194 is shown. Integrated video camera 194 may be integrated into the handset 104 of the A/V telecommunication device. The video camera 194 may be integrated as a free-standing unit and may be wired to A/V telecommunication device 100 or may communicate with A/V telecommunication device 100 by a standard wireless protocol. The video camera 194 may typically be a CCD camera device.

The video data collected by video camera 194 may be displayed at A/V telecommunication terminal 100 on display 103. The video data may be stored at A/V telecommunication terminal 100 in memory 140. The video data may be transmitted to server-202 via network 106 for storage in memory 221. The video data, either live or as stored in memory, may be delivered to another A/V telecommunication device 100a for viewing on display 103a.

With reference to FIG. 4, an A/V telecommunications device 100 with an integrated VOIP MTA 176 is shown. The VOIP multimedia terminal adapter 176 manages the connection of the A/V telecommunications device 100 with voice-over-IP telephony. When a incoming or outgoing telephone call is initiated, the signal goes through a VOIP server 178 connected to a POTS 180 communicably connected to VOIP multimedia terminal adapter 176. The VOIP multimedia terminal adapter 176 may implement media manipulation including sampling, encoding or decoding, encapsulation such as encryption or framing and call signaling protocols.

With reference to FIG. 4, an A/V telecommunication device 100 having an integrated digital jukebox 198 is shown. The A/V telecommunication device 100 receives music files from music server 196 over network 106 in cooperation with host server 202. The integrated digital jukebox may be implemented in software within the A/V telecommunication device 100 or may function as a communicably connected unit. The digital jukebox 198 may store the music files or the music files may be stored in memory 140 or may be stored off-site at host server memory 221 or music server 196. The digital jukebox 198 processes the music files, which may be in the form of streaming music files and typically translates the music files into analog signals for broadcast over speakers.

With reference to. FIG. 4, an A/V telecommunication device 100 having an integrated resource management organizer 402 is shown. The integrated resource management organizer 402 receives input from a user via the A/V telecommunication device 100. The integrated resource management organizer 402 may receive input from a content provider 204 or the host server 202. The resource management organizer 402 may allow a user to manage an address book, calender, to-do list or other forms of resource management. The organizer 402 may permit the use of video and audio files to record entries in the resource management organizer 402. The data may be stored in memory 140.

With reference to FIG. 4, an A/V telecommunication system including an A/V telecommunication device 100 with an integrated ticket server 418. The user of the A/V telecommunication device 100, typically in response to information viewed on display 103 orders tickets for a performance, event, show, travel, etc. Communication is established by the host server 202 between a ticket source 416 and the A/V telecommunication device 100 with an integrated ticket server 418. The transaction is managed by the integrated ticket server 418. Authentication codes may be sent from the ticket source to the ticket server, to provide authentication for the tickets purchased and printed on printer 182.

It will be appreciated by those skilled in the art having the benefit of this disclosure that this invention provides a broadband information appliance. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. An information appliance system comprising:
a network connection;
a telecommunications processor connected to the network connection and providing two-way communication;
a video processor connected to the network connection; and
an optical reader connected to the network connection;
wherein a request signal is sent to a server via the network connection in response to the optical reader reading a code and an associated provider sends content to said information appliance in response to said received request signal.

2. A system for providing on-screen management of content delivery to an audio-video telecommunications terminal comprising:
a network connection;
a telecommunications processor connected to the network connection;
a video processor connected to the network connection;
a display connected to the video processor; and
wherein said display provides visual displays for programming the delivery of content to the video processor via the network.

3. A method of delivering content to an A/V telecommunication device in response to a scanned code comprising the steps of:
reading a machine readable code;
sending a signal to a host server in response to the read code; and
receiving content from a content provider in response to the signal sent to the host server.

4. A method of providing messages on an A/V telecommunication system comprising the steps of:
recognizing an unanswered A/V communication;
sending recorded A/V content to a calling A/V telecommunication device;
recording A/V message content from the calling A/V telecommunication device;
receiving a request for messages;
sending recorded A/V content to a called A/V telecommunication device; and
sending recorded A/V message content to a called A/V telecommunication device.

5. An information appliance comprising:
a network connection;
a telecommunications processor connected to the network connection;
a video processor connected to the network connection;
a transceiver connected to said telecommunication processor; and
a wireless handset communicably connected to said transceiver.

6. An information appliance comprising:
a network connection;
a telecommunications processor connected to the network connection;
a video processor connected to the network connection;
a wireless transceiver connected to said video processor; and
a digital image device communicably connected to said wireless transceiver.

7. An information appliance comprising:
a network connection;
a telecommunications processor connected to the network connection;
a video processor connected to the network connection;
a housing containing said telecommunication processor and said video processor;
a video display holder connected to said housing;
a video display interface connected to said video processor;
wherein a video display unit may be connected to said video display interface; and
attached to said video display holder.

8. An information appliance comprising:
a network connection;
a telecommunications processor connected to the network connection;
a video processor connected to the network connection; and
a digital camera connected to said video processor.

9. An information appliance comprising:
a network connection;
a telecommunications processor connected to the network connection;
a video processor connected to the network connection;
a display connected to said video processor;
an optical scanner communicably connected to said video processor; and
such that when the optical scanner scans an optical code, the display is activated.

10. A method of caller identification on an A/V telecommunication device having a network connection, a telecommunications processor connected to the network connection and a video processor connected to the network connection, said system comprising the steps of:
receiving caller identification information with an incoming call;
retrieving an image file associated with said caller information; and
displaying said image file on the A/V telecommunication device.

11. A method of caller identification in an A/V telecommunication system including a host server with a host server memory communicably connected to an AW telecommunication device, the method comprising the steps of:
detecting by the host server of an incoming call from a source to an A/V telecommunication device;
receiving source information regarding the source by the host server;
retrieving identification data associated with the source information by the host server; and
sending identification data to said AW telecommunication device by the host server.

12. An A/V telecommunication device comprising:
a network connection;
a telecommunications processor connected to the network connection;
a video processor connected to the network connection; and
an integrated network radio receiver communicably connected to the network connection;
to receive network radio broadcast signals over said network.

13. An A/V telecommunication device including a network connection, a telecommunications processor connected to the network connection and a video processor connected to the network connection; said device comprising:
an integrated coupon server communicably connected to said network connection; and
a printer communicably connected to said coupon server.

14. An A/V telecommunication device comprising:
a network connection;
a telecommunications processor connected to the network connection;
a video processor connected to the network connection; and
an integrated optical scanner communicably connected to said telecommunications processor.

15. An information appliance comprising:
a network connection;
a telecommunications processor connected to the network connection;
a video processor connected to the network connection; and
an integrated video camera communicably connected to said video processor.

16. An A/V telecommunication terminal comprising,
a network connection;
a telecommunications processor connected to the network connection;
a video processor connected to the network connection; and
an integrated VOIP multimedia terminal adapter.

17. An A/V telecommunication device comprising a network connection;
a telecommunications processor connected to the network connection;
a video processor connected to the network connection; and
a digital jukebox communicably connected to said network.

18. An A/V telecommunication device comprising:
a network connection;
a telecommunications processor connected to the network connection;
a video processor connected to the network connection; and
an integrated resource management organizer communicably connected to said video processor.

19. An A/V telecommunication device comprising:
a network connection;
a telecommunications processor connected to the network connection;
a video processor connected to the network connection; and
an integrated ticket server communicably connected to the network connection.
